(19) United States
(12) Patent Application Publication
(10) Pub. No.: US 2009/0132268 A1
(43) Pub. Date: May 21, 2009

(54) Presence-based, heterogeneous device utilization analytics

(76) Inventor: Christopher J. Vitek, Elliott City, MD (US)

Correspondence Address: Christopher J. Vitek, 5115 Little Creek Drive, Ellicott City, MD, 21043, US

(21) Appl. No.: 11/984,553

(22) Filed: Nov. 20, 2007

(51) Int. Cl. G06Q 10/00

(52) U.S. Cl. 705/1

(57) ABSTRACT

The present invention uses the information gleaned from communications set-up signaling to provide business enterprises computer displays of utilization rates of presence-enabled computers, telephones, and/or other business machines. Further the present invention provides comparisons and correlations of this data to business enterprise financial data, business enterprise human resources data and business enterprise manufacturing data. These displays are provided in both real-time and historical contexts.

### FIELD OF INVENTION

Presence-based productivity analytics collect and manipulate presence information to create management reports that measure utilization of presence-enabled telephones, computers and/or other business machines. These reports are unique in that they compare and correlate enterprise financial metrics, human resources metrics and manufacturing metrics with computer, telephone and/or other business machine utilization metrics. These reports depict the amount of work performed by employees and/or groups of employees while using their presence-enabled computers, telephones and/or other business machines. All of these reports are presented on a real-time basis and on an historical basis.

The use of presence-aware applications is increasing in both telephony and computing. Presence is the ability to transfer or broadcast real-time availability information from presence-enabled telephones, computers and other business machines to other users throughout a plurality of Internet protocol-based networks. This information is used by presence-aware applications to support the set-up signaling for the establishment of communications sessions between devices. The Internet Engineering Task Force and the International Telecommunication Union have both defined presence within their Session Initiation Protocol (SIP) specifications. Presence is a message-set within SIP that broadcasts the ability of a SIP-based device to make itself available to receive communications. Instead of a central server providing dial-tone to a phone, presence-enabled devices broadcast their own dial-tone in the form of a presence signal. Further, presence operates in a similar fashion to a screen saver on a computer in that it is sensitive to the computer user's interaction. When the user is engaged in the utilization of the device, then the presence value is set to “on-line.” When the user stops using the device, then the presence value is set to “off-line.” Communication can be established with devices that are “on-line,” not “off-line.”

The present invention uses the information gleaned from the communications set-up signaling that is a sub-function of peer-to-peer applications like Session Initiation Protocol to support the calculation of presence-enabled business tool utilization. In the business enterprise setting, this data is analogous to work performed. This data is further combined and correlated with historical trends to provide business enterprises with a real-time and historical predictor of efficiency and profitability. Further, displays are segmented by user, groups of users, machine, groups of machines, application and/or groups of applications. This segmentation provides business enterprises the ability to identify beneficial or un-beneficial trends in business tool utilization in real-time for any user, group of users, machine, group of machines, application and/or group of applications.

### BACKGROUND OF THE INVENTION

Presence is part of the communications set-up signaling that is a sub-function of peer-to-peer applications like Session Initiation Protocol (SIP). Presence is the ability to make SIP servers and SIP users aware that a device has the ability to accept communications.

The Internet Engineering Task Force (IETF) Request for Comments (RFC) 3856 states the following concerning SIP-Based Presence:

“Presence is defined as the willingness and ability of a user to communicate with other users on the network. Historically, presence has been limited to “on-line” and “off-line” indicators; the notion of presence here is broader. Subscriptions and notifications of presence are supported by defining an event package within the general SIP event notification framework.”

The exchange of Presence data between SIP users is a communication of the state of the user's device. If the state of the user is adverse, then communications cannot be established using SIP. SIP-based communications applications contain parameters for defining their state. Most SIP applications define a timing parameter for modification of the state of the SIP user. A typical example would be: if the user has not touched their computer keyboard in the last 3 minutes, then broadcast the presence signal of “off-line,” else, broadcast the presence signal of “on-line.”

SIP utilizes presence data to establish communications. Once used, this data is discarded by the communications application. Presence-based productivity analytics are unique in that they gather and archive presence data.

Employees in all professions are measured by the number of hours that they work. As businesses grow management loses visibility into the productivity of employees, and/or departments. “Hours worked” as measured by a time-clock do not provide a good measure of productivity. Time spent at the water cooler is not measured any differently than time spent on the phone with a customer. Presence-based productivity analytics provide a measurement of the white-collar employees' utilization rates of the tools-of-the-trade (computers, telephones and/or other business machines). By measuring utilization of these tools the business enterprises can more accurately understand how productive their employees are. Through this approach the employer can determine how resource utilization and hours worked are related in real-time or on an historical basis. Ultimately, each employer that uses presence-based productivity analytics can more accurately assess the productivity of their employees.

There are many systems that measure utilization within specific, homogeneous computer or specific, homogeneous telephony systems. Presence-based productivity analytics are unique in that they provide a mechanism for blending utilization information together from two or more, heterogeneous systems. The use of presence as a mechanism for gathering utilization data is unique. The storage of historical presence data is unique. The ability to combine presence data with other enterprise data to present real-time and historical reports is also unique.

### SUMMARY OF THE INVENTION

Presence-based productivity analytics provides a unique measurement tool for business enterprises that seek to more rapidly and accurately measure the amount of productive work performed within their enterprise. Presence-based productivity analytics are supported by the collection and storage of presence data that is received from telephones, computers and/or other business devices. These systems include private branch exchange-based telephones, wireless computers, wireless telephones, wireless e-mail devices, wireless pagers, internet protocol telephony-based telephones, hand-held computers, personal computers, Minicomputer, Mainframe, etc . . . By aggregating the data collected from presence-aware devices the present invention can accurately measure the utilization of business tools (presence-enabled computers, telephones or machines) across a business enterprise. Presence-based productivity analytics are unique in that they use presence data to determine utilization of any computer or telephone and/or other business device. Further, the ability to measure and analyze aggregate or segmented device utilization is an accurate predictor of business enterprise productivity in real-time or on an historical basis. This information is unique and useful to business enterprises.

### DETAILED DESCRIPTION OF THE INVENTION

It is an object of the present invention through the collection, storage and manipulation of presence data to provide a method for measuring the aggregated or segregated work that was performed by a user or a group of users by measuring how much time they were engaged in the use of software or firmware applications on their computers, telephones and/or business machines.

It is an object of the present invention through the collection, storage and manipulation of presence data to provide real-time, graphical and/or text-based computer displays of aggregated or segmented utilization rates of computer-based applications, telephone-based applications and/or other machine-based applications.

It is an object of the present invention through the collection, storage and manipulation of presence data to provide real-time, graphical and/or text-based computer displays of aggregate or segmented data about user's or groups of users' utilization of computers, telephones and/or other machines.

It is an object of the present invention through the collection, storage and manipulation of presence data to prepare statistical, real-time and historical comparisons and correlations of business enterprise expense, revenue, profitability, human resources, and manufacturing data with segmented and aggregated utilization data for computers, telephones and/or other machines.

What is claimed is:

1. A method and mechanism for the statistical calculation of aggregated, segregated, real-time and historical utilization rates of two or more heterogeneous, presence-enabled computers, telephones and/or other machines;

2. The method and mechanism of claim 1; wherein said calculated data are aggregated and segregated by users and groups of users and statistically compared and/or correlated with business enterprise financial metrics, business enterprise human resources metrics and business enterprise manufacturing metrics.

3. A method and mechanism for assembling computer displays of real-time, historical, text-based and/or graphically-based information that depicts the aggregated or segregated utilization rates of two or more heterogeneous, presence-enabled computers, telephones and/or other machines;

4. The method and mechanism of claim 3; wherein said displays are aggregated and segregated by users and groups of users and contain comparisons and correlations with data from business enterprise financial data, business enterprise human resources data and/or business enterprise manufacturing data;

5. A computer-based, presence-enabled, Internet protocol network-enabled, optical and/or mechanical sensor that can detect the utilization of computers, telephones and/or other machines.
